(19) United States
(12) Patent Application Publication
(10) Pub. No.: US 2025/0236725 A1
(43) Pub. Date: Jul. 24, 2025

(54) POLYPROPYLENE COMPOSITION HAVING LOW SIT

(71) Applicant: Basell Poliolefine Italia S.r.l., Milano (IT)

(72) Inventors: Monica Galvan, Ferrara (IT); Gianni Perdomi, Ferrara (IT); Michele Grazzi, Ferrara (IT); Roberta Marchini, Ferrara (IT)

(73) Assignee: Basell Poliolefine Italia S.r.l., Milano (IT)

(21) Appl. No.: 18/702,219

(22) PCT Filed: Oct. 12, 2022
(86) PCT No.: PCT/EP2022/078347

§ 371 Date: Apr. 17, 2024

(30) Foreign Application Priority Data
Oct. 22, 2021 (EP) 21204116.4

(51) Int. Cl. C08L 23/16

(52) U.S. Cl. CPC C08L 23/16

(57) ABSTRACT

A polymer composition made from or containing:
A) from 70 wt % to 95 wt % of a propylene ethylene copolymer having:
   an ethylene derived units content, measured by ¹³C NMR, ranging from 2.2 wt % and 9.8 wt %; and
B) from 5.0 wt % to 30.0 wt % of a copolymer of 1-butene and ethylene containing from 3.0 wt % to 4.2 wt % of ethylene derived units,
wherein the sum of the amounts of A) and B) being 100 wt %.

### FIELD OF THE INVENTION

In general, the present disclosure relates to the field of chemistry. More specifically, the present disclosure relates to polymer chemistry. In particular, the present disclosure relates to propylene compositions and films made therefrom.

### BACKGROUND OF THE INVENTION

In some instances, polypropylene compositions are used for making films in the packaging field and in non-packaging field. In some instances, polypropylene compositions are used in food and non-food packaging applications.

In some instances, the packaging is used for hygienic items, textile articles, magazines, mailing films, secondary collation packaging, shrink packaging films and sleeves, stretch packaging films and sleeves, form-fill-seal packaging films for portioning various types of articles, and vacuum formed blisters. In some instances, the articles are bags, pouches, or sachets.

In some instances, form-fill-seal applications include packaging of peat and turf, chemicals, plastic resins, mineral products, food products, and small size solid articles.

As used herein, the term “flexible plastic packaging” includes plastic films for packaging.

In some instances, non-packaging items include synthetic clothing articles, medical and surgical films, films which are formed into flexible conveying pipes, membranes for isolation and protection in soil, building and construction applications, and films which are laminated with non-woven membranes.

### SUMMARY OF INVENTION

In a general embodiment, the present disclosure provides a polymer composition made from or containing:
A) from 70 wt % to 95 wt % of a propylene ethylene copolymer having
   i) an ethylene derived units content, measured by ¹³C NMR, ranging from 2.2 wt % to 9.8 wt %, based upon the total weight of the propylene ethylene copolymer;
   ii) a Melt Flow Rate, measured according to ISO 1133-2011-(230° C., 2.16 Kg), ranging from 0.5 to 14.0 g/10 min;
   iii) a melting point, measured by DSC, ranging from 130° C. to 142° C.; and
   iv) a fraction soluble in xylene at 25° C. ranging from 10 wt % to 21 wt %, based upon the total weight of the propylene ethylene copolymer; and
B) from 5.0 wt % to 30.0 wt % of a copolymer of 1-butene and ethylene containing from 3.0 wt % to 4.2 wt % of ethylene derived units, based upon the total weight of the copolymer of 1-butene and ethylene, and having:
   i) a Melt Flow Rate, measured according to ISO 1133-2011-(190° C., 2.16 Kg), ranging from 1.0 to 5.5 g/10 min;
   ii) a Flexural modulus, measured according to ISO 178 2010, ranging from 50 MPa to 250 MPa; and
   iii) a melting temperature, measured according to ISO 11357-2013, ranging from 83° C. to 108° C., form I;
wherein the sum of the amounts of A) and B) being 100 wt %.

### DETAILED DESCRIPTION OF THE INVENTION

In some embodiments, the present disclosure provides a polymer composition made from or containing:
A) from 70.0 wt % to 95.0 wt %; alternatively from 72.0 wt % to 93.0 wt %; alternatively from 74.0 wt % to 87.0 wt %, of a propylene ethylene copolymer having:
   i) an ethylene derived units content, measured by ¹³C NMR, ranging from 2.2 wt % to 9.8 wt %; alternatively from 3.2 wt % to 8.2 wt %; alternatively from 4.5 wt % to 7.2 wt %, based upon the total weight of the propylene ethylene copolymer;
   ii) a Melt Flow Rate, measured according to ISO 1133-2011 (230° C., 2.16 Kg), ranging from 0.5 to 14.0 g/10 min; alternatively from 0.8 to 12.0 g/10 min; alternatively from 1.0 to 9.0 g/10 min;
   iii) a melting point, measured by DSC, ranging from 130° C. to 142° C.; alternatively from 131° C. to 140° C.; alternatively from 132° C. to 137° C.; and
   iv) a fraction soluble in xylene at 25° C. ranging from 10 wt % to 21 wt %; alternatively from 10 wt % to 17 wt %; alternatively from 11 wt % to 16 wt %; alternatively from 13 wt % to 16 wt %, based upon the total weight of the propylene ethylene copolymer; and
B) from 5.0 wt % to 30.0 wt %; alternatively from 7.0 wt % to 28.0 wt %; alternatively from 13.0 wt % to 26 wt %, of a copolymer of 1-butene and ethylene containing from 3.0 wt % to 4.2 wt % alternatively from 3.2 wt % to 4.0 wt %; alternatively from 3.3 wt % to 3.9 wt %, of ethylene derived units, based upon the total weight of the copolymer of 1-butene and ethylene, and having:
   i) a Melt Flow Rate, measured according to ISO 1133-2011-(190° C., 2.16 Kg), ranging from 1.0 to 5.5 g/10 min; alternatively from 2.1 to 4.8 g/10 min; alternatively from 2.4 to 4.1 g/10 min;
   ii) a Flexural modulus, measured according to ISO 178-2010, ranging from 50 MPa to 250 MPa; alternatively ranging from 80 MPa to 210 MPa; alternatively ranging from 92 MPa, to 174 MPa; and
   iii) a melting temperature, measured according to ISO 11357-2013, ranging from 83° C. to 108° C., alternatively ranging from 84° C. to 103° C.; alternatively ranging from 88° C. to 100° C., form I;
wherein the sum of the amounts of A) and B) being 100 wt %.

As used herein, the term “copolymer” refers to polymers containing two comonomers such as propylene and ethylene, 1-butene and ethylene, or propylene and 1-butene, in the absence of other monomers.

In some embodiments, the propylene ethylene copolymer (A) is commercially available under the tradenames Clyrell RC110E and Clyrell RC112L from LyondellBasell.

In some embodiments, component B) is a 1-butene ethylene copolymer commercially available under the tradename Koattro DP 8310M from LyondellBasell.

In some embodiments, the polymer composition is prepared by mechanically blending component A) and component B).

In some embodiments, the polymer composition is used for the preparation of films, alternatively cast and blow films.

In some embodiments, the present disclosure provides a film made from or containing the polymer composition. In some embodiments, the film is a cast film or a blow film made from or containing the polymer composition.

In some embodiments, the polymer composition is further made from or containing additives.

In some embodiments, the polymer composition is used as a sealing layer in a multilayer film, thereby allowing the film to seal at a lower temperature.

In some embodiments, the polymer composition has a seal initiation temperature (SIT) lower than 118° C.° alternatively lower than 117° C.; alternatively lower than 115° C. In some embodiments, the polymer composition has a SIT higher than 90° C.

In some embodiments, the polymer composition has a hot tack at 120° C. ranging from 1.20 N to 10.0 N; alternatively from 3.0 to 9.5 N. In some embodiments, the polymer composition has a hot tack at 125° C. ranging from 2.3 N to 6.0 N.

In some embodiments, the polymer composition consists essentially of components A) and B).

As used herein, the term “consists essentially of” refers to the presence of specific further components, which components do not materially affect the essential characteristics of the compound or composition. In some embodiments, no further polymers are present in the polymer composition. In some embodiments, no further polyolefins are present in the polymer composition.

The following examples are given to illustrate, but not limit, the present disclosure.

### EXAMPLES

Melt Flow Rate: measured according to ISO 1133-2011 (230° C., 2.16 Kg for propylene based polymer or 190° C., 2.16 Kg for 1-butene based polymers).

Flexural Modulus according to ISO 178-2010, and supplemental conditions according to ISO 1873-2012.

### Melting Temperature (ISO 11357-2013)

The melting temperature TmI was the melting temperature attributable to the crystalline form I of the copolymer. To determine the TmI, the copolymer sample was melted and then cooled down to 20° C. with a cooling rate of 10° C./min., maintained for 10 days at room temperature, and then subjected to differential scanning calorimetry (DSC) analysis by cooling to −20° C. and then heating to 200° C. with a scanning speed corresponding to 10° C./min. In this heating run, the peak in the thermogram was taken as the melting temperature (TmI).

### Ethylene Content in a 1-Butene Ethylene Copolymer

The content of comonomers was determined by infrared spectroscopy by collecting the IR spectrum of the sample vs. an air background with a Fourier Transform Infrared spectrometer (FTIR). The instrument data acquisition parameters were:
purge time: 30 seconds minimum
collect time: 3 minutes minimum
apodization: Happ-Genzel
resolution: 2 cm⁻¹.

Sample Preparation—Using a hydraulic press, a thick sheet was obtained by compression molding about 1 gram of sample between two aluminum foils. A small portion was cut from this sheet to mold a film. The film thickness was set to have a maximum absorbance of the CH₂ absorption band recorded at ˜720 cm⁻¹ of 1.3 a.u. (% Transmittance >5%). Molding conditions were a temperature of 180±10° C. (356° F.) with a pressure around 10 kg/cm² (142.2 PSI) for about one minute. The pressure was then released. The sample was removed from the press and cooled to room temperature. The spectrum of pressed film sample was recorded in absorbance vs. wavenumbers (cm⁻¹). The following measurements were used to calculate ethylene (C₂) and 1-butene (C₄) contents:
a) Area (Aₜ) of the combination absorption bands between 4482 and 3950 cm⁻¹ which was used for spectrometric normalization of film thickness.
b) Area (A_{C2}) of the absorption band due to methylenic sequences (CH₂ rocking vibration) in the range 660 to 790 cm⁻¹ after a proper digital subtraction of an isotactic polypropylene (IPP) and a C₂C₄ standard spectra.
c) The factor of subtraction (FCR_{C4}) between the spectrum of the polymer sample and the C₂C₄ standard spectrum. The standard spectrum was obtained by digital subtraction of a linear polyethylene from a C₂C₄ copolymer, thereby extracting the C₄ band (ethyl group at ˜771 cm−1).

The ratio A_{C2}/Aₜ was calibrated by analyzing standard ethylene-1-butene copolymer compositions, determined by NMR spectroscopy. To calculate the ethylene (C₂) and 1-butene (C₄) content, calibration curves were obtained by using standard samples of ethylene and 1-butene detected by ¹³C-NMR.

Calibration for ethylene—A calibration curve was obtained by plotting A_{C2}/Aₜ versus ethylene molar percent (% C2m), and the coefficient a_{C2}, b_{C2} and c_{C2} were calculated from a “linear regression”.

Calibration for 1-butene—A calibration curve was obtained by plotting FCR_{C4}/Aₜ versus butane molar percent (% C₄m) and the coefficients a_{C4}, b_{C4} and C_{C4} were calculated from a “linear regression”.

The spectra of the samples were recorded. The (Aₜ), (A_{C2}), and (FCR_{C4}) of the samples were calculated.

The ethylene content (% molar fraction C2m) of the sample was calculated as follows:

$$\% C 2 m = - {b}_{C 2} + \frac{\sqrt{{b}_{C 2}^{2} - 4 \cdot {a}_{C 2} \cdot ( {c}_{C 2} - \frac{{A}_{C 2}}{{A}_{t}} )}}{2 \cdot {a}_{C 2}}$$

The 1-butene content (% molar fraction C4m) of the sample was calculated as follows:

$$\% C 4 m = - {b}_{C 4} + \frac{\sqrt{{b}_{C 4}^{2} - 4 \cdot {a}_{C 4} \cdot ( {c}_{C 4} - \frac{F C {R}_{C 4}}{{A}_{t}} )}}{2 \cdot {a}_{C 4}}$$

a_{C4}, b_{C4}, c_{C4} a_{C2}, b_{C2}, and c_{C2} are the coefficients of the two calibrations.

Changes from mol % to wt % were calculated by using molecular weights.

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

$$PPP = 100 {T}_{β β} / S \qquad PPE = 100 {T}_{β δ} / S \qquad EPE = 100 {T}_{δ δ} / S$$

$$PEP = 100 {S}_{β β} / S \qquad PEE = 100 {S}_{β δ} / S \qquad EEE = 10 \; 0 ( 0.25 {S}_{γ δ} + 0.5 {S}_{δδ} ) / S$$

$$S = {T}_{β β} + {T}_{β δ} + {T}_{δδ} + {S}_{β β} + {S}_{β δ} + 0.25 {S}_{γ δ} + 0.5 {S}_{δ δ}$$

The molar percentage of ethylene content was evaluated using the following equation:

$$E \% mol = 100 * [ PEP + P E E + E E E ]$$

The weight percentage of ethylene content was evaluated using the following equation:

$$E \% wt . = \frac{* E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm) Solubility in xylene at 25° C.

Xylene Solubles were measured according to ISO 16 152-2005; with solution volume of 250 ml, precipitation at 25° C. for 20 minutes, 10 minutes of which with the solution in agitation (magnetic stirrer), and with drying at 70°.

### Seal Initiation Temperature (SIT)

### Preparation of the Film Specimens

Some cast films with a thickness of 50 μm were prepared by extruding each test composition in a single screw Collin extruder (length/diameter ratio of screw 1:25) at a film drawing speed of 7 m/min and a melt temperature of 210-250° C.

### Determination of the SIT.

Film strips, 6 cm wide and 35 cm length, were cut. Two film strips were superimposed. The superimposed specimens were sealed along one of the 2 cm sides with a Brugger Feinmechanik Sealer, model HSG-ETK 745. Sealing time was 5 seconds at a pressure of 0.14 MPa (20 psi). The starting sealing temperature was from about 90° C. The sealed strip was cut into 6 specimens, 15 mm wide, and long enough to be held in the tensile tester grips. The seal strength is tested at a load cell capacity 100 N, cross speed 100 mm/min, and grip distance 50 mm. The seal strength was measured as the average value of 6 specimens. The test was repeated by increasing the temperature of 5° C. When there were three temperatures, which the seal strength differs of less than 3 N, the plateau was reached. The average plateau strength was calculated. The SIT was calculated on the seal plot as the temperature corresponding to half of the plateau seal strength.

### Determination of the Hot Tack

The hot tack measurement was determined after sealing by Brugger HSG Heat-Sealer (with Hot Tack kit). Samples obtained from cast film were cut at a minimum length of 200 mm and 15 mm width and tested at the following conditions:

The temperature was set from no sealing to 130° C. with an increase of 5° C. steps; at each temperature, the force to break the film was set in the neighborhood of the seal.

As used herein, a break of specimen occurred when 50% or more of the seal part was open after the impact.

### Components A and B

Component A was commercially available under the tradenames Clyrell R110E and Clyrell R112L from LyondellBasell. Component B was commercially available under the tradename Koattro DP 8310M from LyondellBasell.

The features of components A are reported in Table 1.

TABLE 1

| | | Component A1 | Component A2 |
|---|---|---|---|
| | | R110E | R112L |
| MFR 230° C. 2.16 kg | g/10 min | 0.8 | 7.0 |
| C2 content in A | wt % | 6.1 | 6.1 |
| Tm | ° C. | 134.5 | 134.0 |
| xylene soluble fraction | wt % | 12 | 15 |
| 25° C. | | | |

C2 = ethylene;

The features of component B are reported in Table 2.

TABLE 2

| | | Component B |
|---|---|---|
| MFR 190° C. 2.16 kg | g/10 min | 3.5 |
| Flexural modulus | MPa | 120 |
| Tm | ° C. | 94 |
| Ethylene content | wt % | 3.7 |

Various amounts of component B were blended with components A. A cast film was produced from the compositions. The seal initiation temperature was measured. Table 3 reports the SIT for each sample. The cast film thickness was 50 micron.

TABLE 3

| | | *ex 1 | ex 2 | ex 3 | ex 4 | *ex 5 | ex 6 | ex 7 | ex 8 |
|---|---|---|---|---|---|---|---|---|---|
| comp A1 | wt % | 100 | 90 | 85 | 80 | | | | |
| comp A2 | wt % | | | | | 100 | 90 | 85 | 80 |
| comp B | wt % | 0 | 10 | 15 | 20 | 0 | 10 | 15 | 20 |
| SIT | ° C. | 118 | 117 | 116 | 113 | 118 | 113 | 113 | 110 |
| Tm | ° C. | 134.5 | 133.2 | 133.2 | 132.6 | 134 | 133.3 | 133.4 | 133.2 |
| Tc | ° C. | 94.5 | 93.4 | 93.3 | 92.3 | 90.4 | 91.7 | 91.4 | 91.3 |
| MFR | g/10 | 0.8 | 0.92 | 1 | 1.1 | 7.0 | 7.4 | 7.5 | 7.5 |
| | min | | | | | | | | |

*comparative

### Hot Tack

The hot tack measured in Newton of the cast films of examples 1-8 were measured at various temperatures. The results are reported in Table 4.

TABLE 4

| | Temp ° C. | | | | |
|---|---|---|---|---|---|
| | 110 | 115 | 120 | 125 | 130 |
| | Max | Max | Max | Max | Max |
| | force | force | force | force | force |
| ex | N | N | N | N | N |
| 1* | 0.6 | 0.9 | 1.1 | 2.2 | 1.8 |
| 2 | 1.6 | 1.3 | 1.4 | 2.3 | 4.0 |
| 3 | 1.6 | 1.6 | 8.0 | 3.5 | 3.0 |
| 4 | 1.9 | 1.8 | 3.1 | 5.0 | 4.9 |
| 5* | 0.8 | 2.4 | 2.5 | 2.6 | 0.4 |
| 6 | 2.2 | 3.2 | 5.1 | 3.2 | nm |
| 7 | 1.3 | 5.7 | 4.0 | 2.2 | nm |
| 8 | 2.7 | 4.1 | 3.9 | 2.8 | nm |

Nm = not measured
*comparative

1. A polymer composition comprising:
A) from 70 wt % to 95 wt % of a propylene ethylene copolymer having
i) an ethylene derived units content, measured by ¹³C NMR, ranging from 2.2 wt % to 9.8 wt %, based upon the total weight of the propylene ethylene copolymer;
ii) a Melt Flow Rate, measured according to ISO 1133-2011-(230° C., 2.16 Kg), ranging from 0.5 to 14.0 g/10 min;
iii) a melting point, measured by DSC, ranging from 130° C. to 142° C.; and
iv) a fraction soluble in xylene at 25° C. ranging from 10 wt % to 21 wt %, based upon the total weight of the propylene ethylene copolymer;
B) from 5.0 wt % to 30.0 wt % of a copolymer of 1-butene and ethylene containing from 3.0 wt % to 4.2 wt % of ethylene derived units, based upon the total weight of the copolymer of 1-butene and ethylene, and having:
i) a Melt Flow Rate, measured according to ISO 1133-2011-(190° C., 2.16 Kg), ranging from 1.0 to 5.5 g/10 min;
ii) a flexural modulus, measured according to ISO 178, ranging from 50 MPa to 250 MPa; and
iii) a melting temperature, measured according to ISO 11357-2013, ranging from 83° C. to 108° C., form I;
wherein the sum of the amounts of A) and B) being 100 wt %.

2. The polymer composition according to claim 1, wherein component A ranges from 72.0 wt % to 93.0 wt %; and component B) ranges from 7.0 wt % to 28.0 wt %.

3. The polymer composition according to claim 1, wherein, in component A),
the ethylene derived units content, measured by ¹³C NMR, ranges from 3.2 wt % to 8.2 wt %.

4. The polymer composition according to claim 1, wherein the 1-butene ethylene copolymer component B) contains from 3.2 wt % to 4.0 wt % of ethylene derived units.

5. The polymer composition according to claim 1, wherein, in component B), the Melt Flow Rate, measured according to ISO 1133-2011-(190° C., 2.16 Kg), ranges from 2.1 to 4.8 g/10 min.

6. The polymer composition according to claim 1, wherein, in component A), the ethylene derived units content measured by ¹³C NMR ranges from 4.5 wt % and 7.2 wt %.

7. The polymer composition according to claim 1, wherein, in component A), the melting point, measured by DSC, ranges from −131° C. to 140° C.

8. The polymer composition according to claim 1, wherein, in component A), the fraction soluble in xylene at 25° C. ranges from 10 wt % to 17 wt %.

9. The polymer composition according to claim 1, wherein, in component A), the fraction soluble in xylene at 25° C. ranges from 11 wt % to 16 wt %.

10. The polymer composition according to claim 1, wherein the 1-butene ethylene copolymer component B) contains from 3.3 wt % to 3.9 wt % of ethylene derived units.

11. The polymer composition according to claim 1, wherein component B) has the melting temperature, measured according to Iso 11357-2013, ranging from 84° C. to 103° C., form I.

12. The polymer composition according to claim 1, wherein component B) has the flexural modulus, measured according to ISO 178-2010, ranging from 80 MPa to 210 MPa.

13. The polymer composition according to claim 1, wherein component A) has the Melt Flow Rate, measured according to ISO 1133-2011 (230° C., 2.16 Kg), ranging from 0.8 to 12.0 g/10 min.

14. A film comprising the polymer composition of claim 1.

15. The film according to claim 14, wherein the film is selected from the group consisting of cast films and blown films.
